(19) United States
(12) Patent Application Publication
(10) Pub. No.: US 2010/0325130 A1
(43) Pub. Date: Dec. 23, 2010

(54) MEDIA ASSET INTERACTIVE SEARCH

(75) Inventors: James A. Baldwin, Redwood City, CA (US); Qing T. Guo, Mountain View, CA (US); Lei Fang, San Jose, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/488,135

(22) Filed: Jun. 19, 2009

(51) Int. Cl. G06F 17/30

(52) U.S. Cl. 707/759; 707/769; 707/776; 707/805

(57) ABSTRACT

Media asset interactive search is described. In embodiments, successive keypad number inputs are received that each correlate to multiple characters of one or more different languages. The successive keypad number inputs form an accumulating search key as they are received. A database is searched for a sequence of characters that correlate to the accumulating search key after each successive keypad number input is received. A list of matching terms can then be generated where the matching terms include the sequence of characters, and the list of matching terms narrows with each successive keypad number input. Additionally, the list of the matching terms can be ordered based on a scoring system.

### BACKGROUND

Searching with a television remote control through a program guide interface can be cumbersome at best in a digital or IP-based television system. However, a television remote control may be the only input device by which a user can interact with a television system. Television remote controls can be difficult to use as text input devices, particularly due to the limited set of input keys that are available on such devices. For example, other than the various configuration and television specific input keys, a television remote control may only have a standard numeric or alphanumeric input keypad that includes the numbers zero through nine to input a channel selection. A viewer cannot easily input letters to initiate a text search for television programming, music, movies, or other television content that may be available from a television system content distributor.

A conventional alphanumeric input keypad on a television remote control or displayed on other electronic devices, such as a cell phone for example, includes the numbers zero through nine along with the alphabetic characters A to Z. The letters are distributed along with the respective keypad numbers two (2) through nine (9). For example, keypad number two (2) includes the letters A, B, and C; keypad number three (3) includes the letters D, E, and F; and so on with each consecutive keypad number being associated with the next consecutive three letters. The letters Q and Z may not be included on some keypads, but if they are, the keypad number seven (7) has four associated letters to include Q and the keypad number nine (9) has four associated letters to include Z.

Techniques are available to enter text with an alphanumeric keypad, however they can be difficult to enter text and in some cases, can require more user inputs than would actually be required to input a text string for the word itself. The techniques to enter text and/or letters with a keypad include multi-tapping, which is also referred to as triple-tap. As described above, the letters A, B, and C are associated with keypad number two (2) on a keypad for triple-tap text entry. Pressing the keypad number once enters an A, twice enters a B, three times enters a C, and four times enters a 2. Spelling out even a short word can require multiple key entries with an alphanumeric keypad. For example, to spell out CAB with triple-tap, a user would have to press keypad number two (2) a total of six times—three more inputs than would be necessary with a conventional keyboard.

### SUMMARY

This summary is provided to introduce simplified concepts of media asset interactive search. The simplified concepts are further described below in the Detailed Description. This summary is not intended to identify essential features of the claimed subject matter, nor is it intended for use in determining the scope of the claimed subject matter.

Media asset interactive search is described. In embodiments, successive keypad number inputs are received that each correlate to multiple characters of one or more different languages. The successive keypad number inputs form an accumulating search key as they are received. A database is searched for a sequence of characters that correlate to the accumulating search key after each successive keypad number input is received. A list of matching terms can then be generated where the matching terms include the sequence of characters, and the list of matching terms narrows with each successive keypad number input. Additionally, the list of the matching terms can be ordered based on a scoring system.

In other embodiments, a matching term can be determined from a character mapping that correlates a character of one of the different languages to a keypad number input. A list of the matching terms can be displayed where the matching terms include any one or combination of a word, a phrase, a sentence, or a character image. The matching terms can be ordered in the list based on the scoring system from a high score to a low score according to first, a matching term that is the sequence of the characters; next, a matching term that includes the sequence of the characters at a beginning of the matching term; next, a matching term that includes the sequence of the characters proximate a beginning of the matching term; and next, a matching term that includes the sequence of the characters.

In other embodiments, additional keypad number inputs can be received that each correlate to a number of character strokes to create a character image in the one or more different languages. The additional keypad number inputs form a character search key as they are received. A database is searched for a sequence of character images that correlate to the character search key after each additional keypad number input is received. A list of matching terms can then be generated where the matching terms include the sequence of the character images, and the list of matching terms narrows with each additional keypad number input. A character image that correlates to a keypad number input can be determined from a character mapping for one of the different languages.

### BRIEF DESCRIPTION OF THE DRAWINGS

Embodiments of media asset interactive search are described with reference to the following drawings. The same numbers are used throughout the drawings to reference like features and components:

FIG. 1 illustrates an example system in which embodiments of media asset interactive search can be implemented.

FIG. 2 illustrates an example of a portable device that can implement various embodiments of media asset interactive search.

FIG. 3 illustrates example method(s) for media asset interactive search in accordance with one or more embodiments.

FIG. 4 illustrates example method(s) for media asset interactive search in accordance with one or more embodiments.

FIG. 5 illustrates various components of an example device that can implement embodiments of media asset interactive search.

### DETAILED DESCRIPTION

Embodiments of media asset interactive search provide techniques for a user of a device to search for titles, identifiers, and/or any other various descriptions of media assets, such as television programming, movies, song selections, contacts, email messages, text messages, digital photos, and the like. A database of metadata that corresponds to the media assets is a combined database that can include the various descriptions of the media assets in multiple languages. Each different language included in a languages database can have a corresponding character mapping to map the characters of a language to the number keys of an alphanumeric keypad. For instance, Chinese characters have a natural mapping through the use of a Pinyin translation of each character, where the first letter of a Pinyin equivalent of each character is used and mapped to a keypad number.

Successive keypad number inputs are received when initiated by a user, and each keypad number input can correlate to characters in one or more of the different languages. An accumulating search key is formed as each successive keypad number input is received and the languages database is searched for terms that contain a sequence of characters that correlate to the accumulating search key. As the keypad number inputs are received, the database is dynamically queried for results that match any of the possible letter and/or character patterns implied by the accumulating search key. As more keypad inputs are received, the number of possible matching results is narrowed down and a list of matching terms is generated for display from which a user can then scroll through the list of matching terms to find or locate a desired term.

While features and concepts of the described systems and methods for media asset interactive search can be implemented in any number of different environments, systems, and/or various configurations, embodiments of media asset interactive search are described in the context of the following example systems and environments.

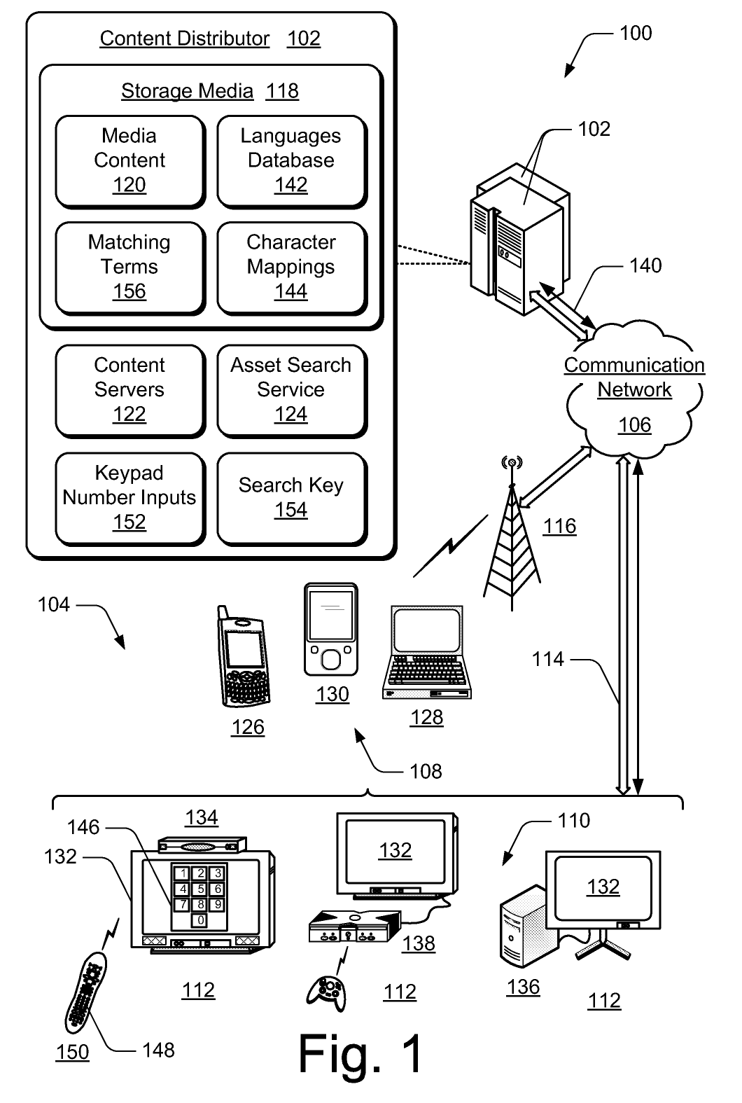

FIG. 1 illustrates an example system 100 in which various embodiments of media asset interactive search can be implemented. In this example, system 100 includes a content distributor 102 that can be configured to communicate or otherwise provide media content and data to any number of various user and/or client devices 104 via a communication network 106. The various devices 104 can include wireless devices 108 as well as other client devices 110 (e.g., wired and/or wireless devices) that are implemented as components in various client systems 112 in a media content distribution system.

The communication network 106 can be implemented to include a broadcast network, an IP-based network 114, and/or a wireless network 116 that facilitates media content distribution and data communication between the content distributor 102 and any number of the various devices 104. The communication network 106 can also be implemented as part of a media content distribution system using any type of network topology and/or communication protocol, and can be represented or otherwise implemented as a combination of two or more networks.

In the example system 100, content distributor 102 includes storage media 118 to store or otherwise maintain various data and media content, such as media content 120. The storage media 118 can be implemented as any type of memory, random access memory (RAM), a nonvolatile memory such as flash memory, read only memory (ROM), and/or other suitable electronic data storage. The content distributor 102 can also include one or more content servers 122 that are implemented to communicate, or otherwise distribute, the media content 120 and/or other data to any number of the various devices.

Media content (e.g., to include recorded media content) can include any type of media asset and audio, video, and/or image media content received from any media content and/or data source. As described herein, media content can include recorded video content, video-on-demand content, television content, television programs (or programming), advertisements, commercials, music, movies, video clips, and other media assets. Other media content can include interactive games, network-based applications, and any other content or data (e.g., to include program guide application data, user interface data, advertising content, closed captions data, content metadata, search results and/or recommendations, etc.).

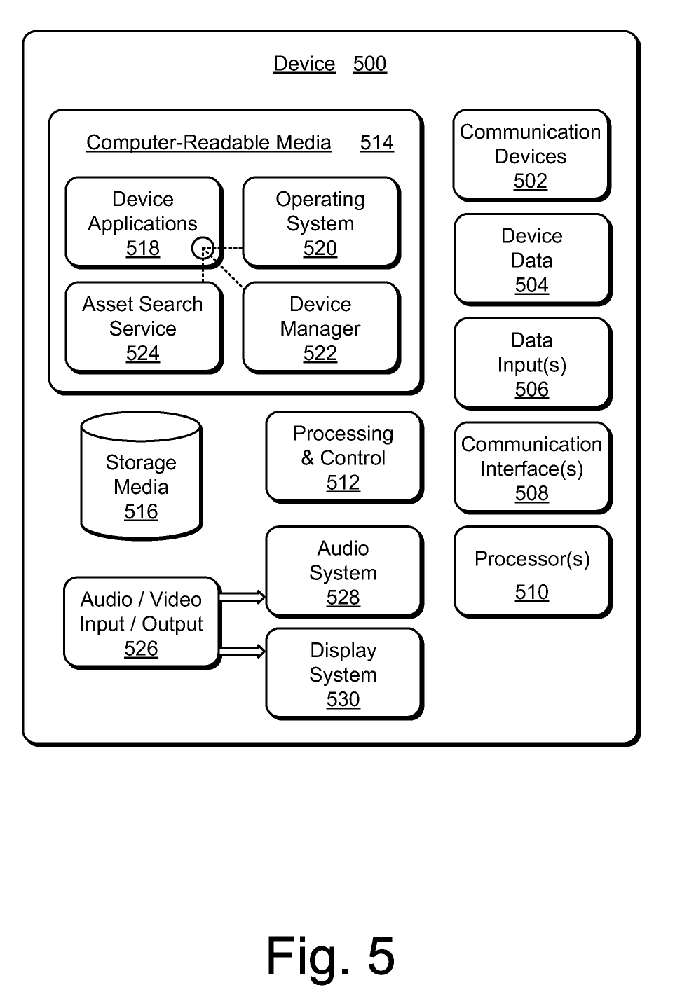

Content distributor 102 also includes an asset search service 124 that can be implemented as computer-executable instructions and executed by processors to implement the various embodiments and/or features of media asset interactive search as described herein. In addition, content distributor 102 can be implemented with any number and combination of differing components as further described with reference to the example device shown in FIG. 5. The asset search service 124, as well as other functionality described to implement embodiments of media asset interactive search, can also be provided as a service apart from the content distributor 102 (e.g., on a separate server or by a third party service).

The wireless devices 108 can include any type of device implemented to receive and/or communicate wireless data, such as any one or combination of a mobile phone 126 (e.g., cellular, VoIP, WiFi, etc.), a portable computer device 128, a media device 130 (e.g., a personal media player, portable media player, etc.), and/or any other wireless devices that receive media content in any form of audio, video, and/or image data. Each of the client systems 112 include a respective client device and a display device 132 that together render or playback any form of audio, video, and/or image media content.

A display device 132 can be implemented as any type of a television, high definition television (HDTV), LCD, or similar display system. A client device in a client system 112 can be implemented as any one or combination of a television client device 134 (e.g., a television set-top box, a digital video recorder (DVR), etc.), a computer device 136, a gaming system 138, an appliance device, an electronic device, and/or as any other type of client device that may be implemented to receive media content in any form of audio, video, and/or image data in a media content distribution system.

Any of the user and/or client devices 104 can be implemented with one or more processors, communication components, memory components, signal processing and control circuits, and a media content rendering system. Further, any of the wireless devices 108 and/or other client devices 110 can be implemented with any number and combination of differing components as further described with reference to the example device shown in FIG. 5. Any of the various devices may also be associated with a user (i.e., a person) and/or an entity that operates the device such that a device describes logical devices that include users, software, and/or a combination of devices.

Any of the wireless devices 108 and/or other client devices 110 can communicate with content distributor 102 via a two-way data communication link 140 of the communication network 106. It is contemplated that any one or more of the arrowed communication link 140, IP-based network 114, and wireless network 116, along with communication network 106, facilitate two-way data communication, such as from a device to the content distributor 102 and vice-versa.

In various embodiments, the asset search service 124 facilitates searching for titles, identifiers, and/or any other various descriptions of any type of media assets in a languages database 142 that includes metadata corresponding to the media assets. The languages database 142 is implemented as a combined database that can include the various descriptions of the media assets in multiple languages. Each different language that is included in the languages database has a corresponding character mapping 144 to map the characters of a language to the number keys of an alphanumeric keypad 146.

For instance, Chinese characters have a natural mapping through the use of a Pinyin translation of each character, where the first letter of a Pinyin equivalent of each character is used and mapped to a keypad number. In this example, the alphanumeric keypad 146 is displayed on the display device 132 that is associated with the television client device 134. The keypad 146 maps to input keys 148 of a remote control device 150 that can be utilized to initiate user-selectable inputs at the television client device 134. In an implementation, an index to the languages database 142 can be created by mapping each character to a respective keypad number equivalent, either directly for English and other Western languages, or through Pinyin for Chinese and through other similar mapping translations for other languages.

The asset search service 124 can receive successive keypad number inputs 152 from a device 104 when initiated by a user, such as with the remote control device 150 to initiate keypad number inputs at television client device 134. Each keypad number input 152 can correlate to characters in one or more different languages that are included in the languages database 142. A character of a particular language can include a letter, a number, a symbol, an image, any other language representation, and/or any combination thereof. Each keypad number input 152 can also be received as a single triple-tap input to a keypad number where each input is only one input to a particular keypad number.

The keypad number inputs 152 that are received by the asset search service 124 form an accumulating search key 154 as each successive keypad number input is received. Each of the successive keypad inputs can be correlated with a respective character, and the languages database 142 can be searched for terms that contain the accumulating search key. For example, the asset search service 124 initiates a search of the languages database 142 for a sequence of characters that correlate to the accumulating search key after each successive keypad number input is received. In an implementation, the asset search service 124 can determine matching terms 156 from a character mapping 144 that correlates a character of one of the different languages to a keypad number input. As keypad number inputs are received, the languages database 142 is dynamically queried for results that match any of the possible letter and/or character patterns implied by the accumulating search key 154.

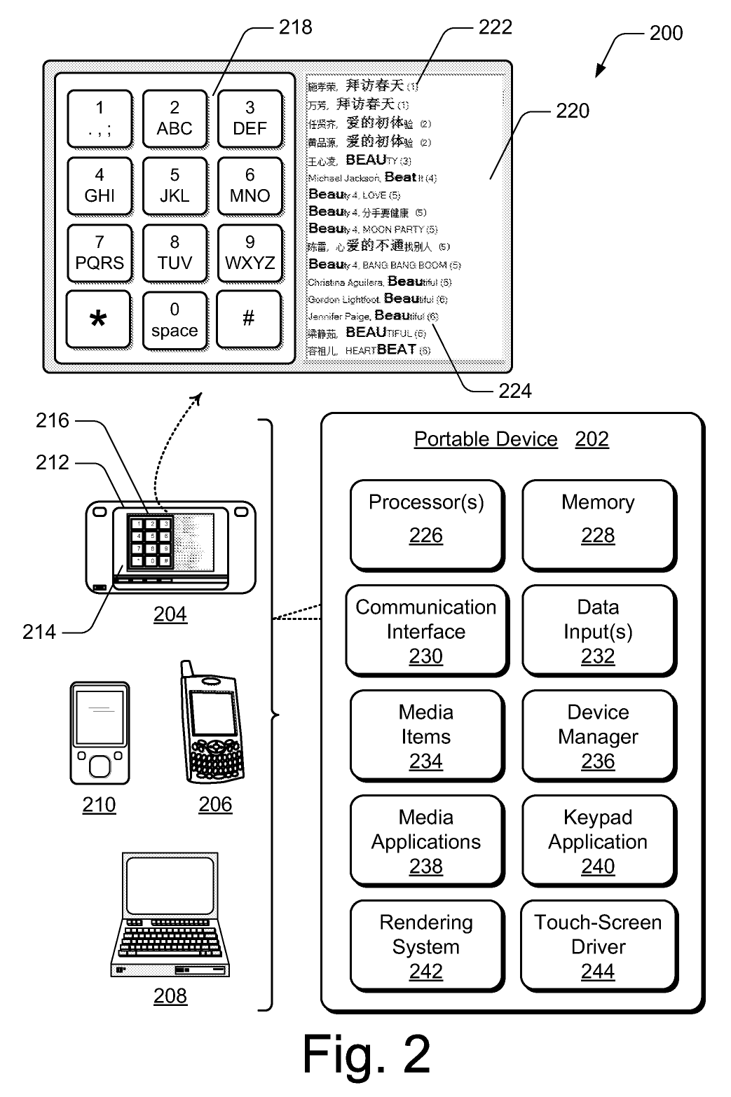

As more keypad inputs are received, the number of possible matching results is narrowed down and a list of matching terms can be generated for display. An example list of matching terms is described with reference to FIG. 2, and a user can then scroll through the list of matching terms to find or locate a desired term. A matching term 156 includes any one of a word, a phrase, a sentence, or a character image that includes the sequence of characters that form the search key 154.

In an embodiment, the asset search service 124 can also be implemented with scoring logic to order the list of the matching terms 156 in an order based on a scoring system. For example, the matching terms are evaluated to determine a degree to which the search key 154 matches an entire word, phrase, sentence, or characters, and the score is used to sort the list in ascending order. The score of a matching term 156 can be based on the number of characters in the sequence of characters that are included in a matching term. Alternatively or in addition, the score of a matching term 156 can be based on the number of characters in the matching term that are not part of the sequence of characters.

A list of the matching terms 156 can be ordered based on a scoring system from a high score to a low score, or any other implemented scoring system. A higher score can be attributed to a matching term that is the sequence of the characters, such as when keypad number inputs 8-2-7 are received that correlate to a search key of characters U-B-R. For instance, a user may desire to locate media content from an artist or band that is known as UBR, and enter the keypad number inputs at television client device 134. It is likely that a short search key of two or three characters will occur in many instances of matching terms in the languages database 142. By attributing a high score to a matching term that is all of the sequence of characters, the matching term will display at or near the top of the list of matching terms and will be easier for the user to locate.

A next score (e.g., less than the high score) can be attributed to a matching term 156 that includes the sequence of the characters at a beginning of the term. For example, the keypad number inputs 8-2-7 may also correlate to a search key of characters T-A-R that are found to be included in a matching term that corresponds to a movie entitled TARGETS in the languages database 142. A next score (e.g., less than the previous two scores) can be attributed to a matching term 156 that includes the sequence of the characters proximate a beginning of the term. For example, the keypad number inputs 8-2-7 may also correlate to a search key of characters V-A-S that are found to be included in a matching term that corresponds to a gaming application entitled EVASIVE ACTION in the languages database 142. Similarly, a next score (e.g., less than the previous three scores) can be attributed to a matching term 156 that includes the sequence of the characters, such as anywhere within the matching term.

In an implementation, a two-tiered scoring system can be applied by first determining how many characters in a matching term precede the search key of characters that are found to be included in the matching term, and then determining how many characters in the matching term come after the search key of characters in the matching term. This two-tiered scoring search includes a primary sort based on proximity of the search key characters to a beginning of a matching term, and a secondary sort based on proximity of the search key characters to an end of the matching term.

In another embodiment, the asset search service 124 can receive a keypad number input 152 from a device 104 when initiated by a user, such as on a touch-screen to initiate a keypad number input to a mobile and/or wireless device 108. The keypad number input 152 can correlate to a number of character strokes to create a character image, such as one to ten strokes to create a Chinese character if the character was written by hand. The asset search service 124 can determine the character image that correlates to the keypad number input from a character mapping 144, such as for Chinese.

As additional keypad number inputs 152 are received that each correlate to a number of character strokes to create character images in one or more different languages, the additional keypad number inputs form a character search key 154. The asset search service 124 can search the languages database 142 for a sequence of character images that correlate to the character search key after each additional keypad number input is received. The asset search service 124 can then generate a list of the matching terms that include the sequence of the character images. In Chinese, a matching term would be one word that correlates to the character search key 154.

Although illustrated and described as a component or module of the content distributor 102, the asset search service 124 can be implemented as an independent service to implement embodiments of media asset interactive search. Further, although the asset search service is illustrated and described as a single component or module, the asset search service 124 can be implemented as several component applications or modules distributed to implement various embodiments of media asset interactive search as described herein.

FIG. 2 illustrates an example system 200 in which various embodiments of media asset interactive search can be implemented. Example system 200 includes a portable device 202 (e.g., a wired and/or wireless device) that can be any one or combination of a mobile personal computer 204, a personal digital assistant (PDA), a mobile phone 206 (e.g., cellular, VoIP, WiFi, etc.) that is implemented for data, messaging, and/or voice communications, a portable computer device 208 (e.g., a laptop computer, a laptop computer with a touch-screen, etc.), a media device 210 (e.g., a personal media player, portable media player, etc.), a gaming device, an appliance device, an electronic device, and/or any other type of portable device that can receive, display, and/or communicate data in any form of audio, video, and/or image data.

Each of the various portable devices can include an integrated display and/or an integrated touch-screen, as well as selectable input controls via which a user can input data and/or selections. For example, the mobile personal computer 204 includes an integrated touch-screen 212 on which a user interface 214 can be displayed that includes displayable objects and/or user interface elements 216, such as any type of image, graphic, text, selectable button, user-selectable control, menu selection, map element, and/or any other type of user interface displayable feature or item.

In this example, the user interface 214 includes an on-screen alphanumeric keypad 218 and a list 220 of matching terms that include a sequence of characters from search keys that correlate to received keypad number inputs 2-3-2-8. The search keys include characters of the different languages, such as [symbol] , B-E-A-U, [symbol] , and B-E-A-T in both English and Chinese. The matching terms in list 220 can be displayed with the matching sequence of characters highlighted (e.g., bolded in this example) in each list entry to provide user feedback about which keypad number inputs are matching in the list of terms. In this example, the matching terms are also ordered based on a high score (1) at 222 to a low score (6) at 224 to indicate which of the matching terms a user is most likely searching for.

Any of the various portable devices can be implemented to communicate with the asset search service 124 at the content distributor 102 (FIG. 1) to implement the various embodiments of media asset interactive search as described herein. Alternatively or in addition, the various portable devices can be implemented with an asset search service or module to implement the various embodiments of media asset interactive search as described herein.

The portable devices can also include one or more sensors, processors, communication components, data inputs, memory components, storage media, processing and control circuits, and/or a content rendering system. Any of the portable devices can be implemented for communication via communication networks that can include any type of a data network, voice network, broadcast network, an IP-based network, and/or a wireless network that facilitates data, messaging, and/or voice communications. A portable device can also be implemented with any number and combination of differing components as described with reference to the example device shown in FIG. 5. A portable device may also be associated with a user (i.e., a person) and/or an entity that operates the device such that a portable device describes logical devices that include users, software, and/or a combination of devices.

In this example, portable device 202 includes one or more processors 226 (e.g., any of microprocessors, controllers, and the like), a memory 228, a communication interface 230 for data, messaging, and/or voice communications, and data inputs 232 to receive media items 234 and/or media content. Media items can include any type of email messages, text messages, digital photos, song selections, search data, and the like. Portable device 202 is implemented with a device manager 236 that includes any one or combination of a control application, software application, signal processing and control module, code that is native to the particular device, and/or a hardware abstraction layer for the particular device.

Portable device 202 includes various media applications 238 that may incorporate components such as a keypad application 240 that can be processed or otherwise executed by the processors 226 to generate the on-screen alphanumeric keypad 218 for display. The media applications 238 can include a music and/or video player, a Web browser, an email application, a messaging application, a photo viewer, and the like. Portable device 202 includes a rendering system 242 to render user interfaces to generate a display on any of the portable devices. The rendering system 242 is also implemented to receive and render any form of audio, video, and/or image data received from any media content and/or data source. Portable device 202 also includes a touch-screen driver 244, such as to implement the mobile personal computer 204 with the integrated touch-screen 212.

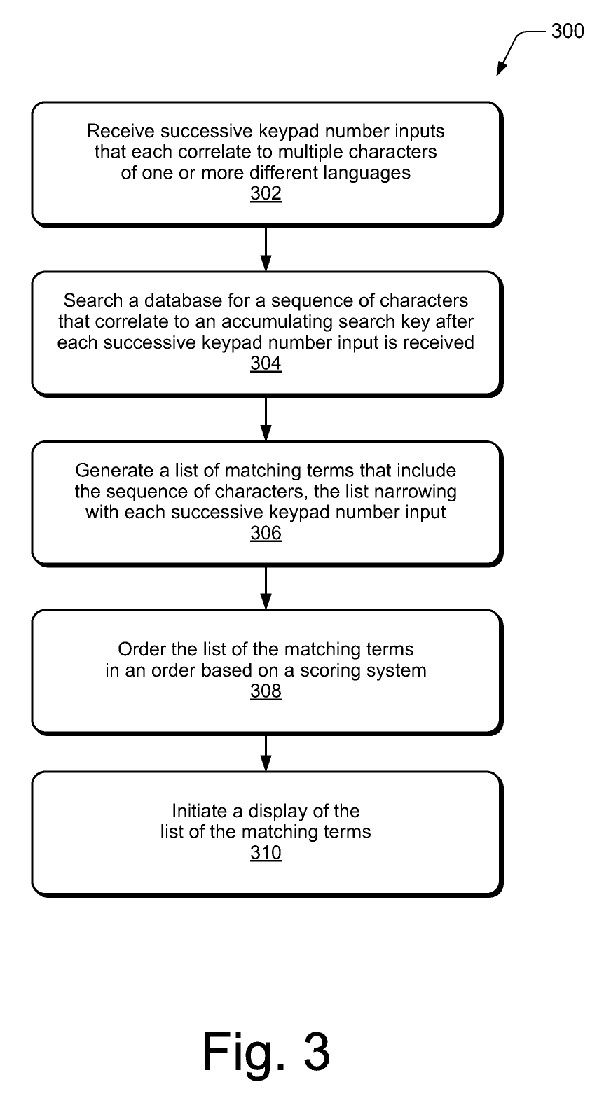

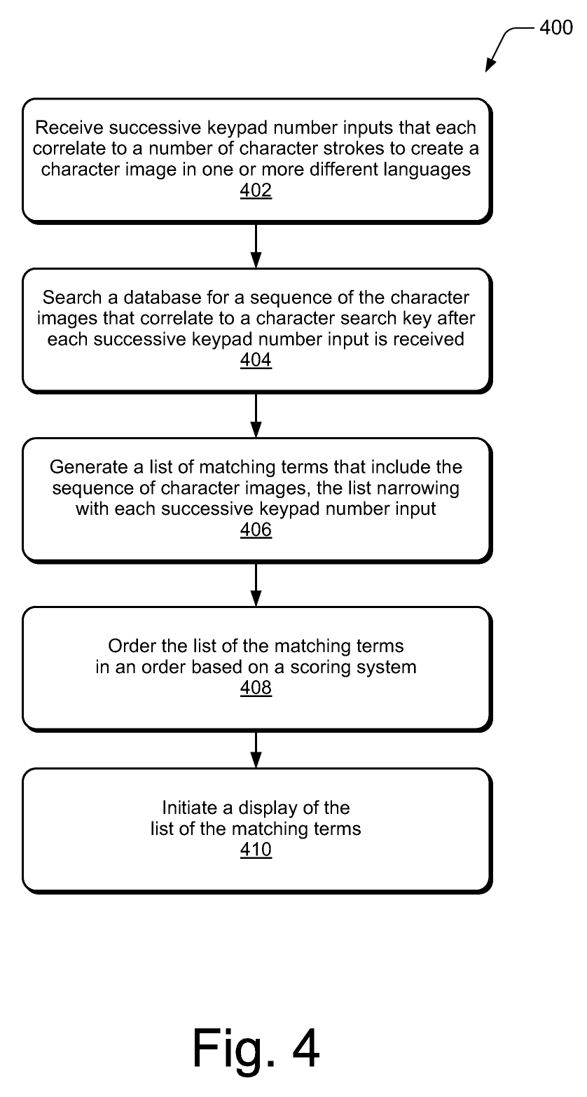

Example methods 300 and 400 are described with reference to respective FIGS. 3 and 4 in accordance with one or more embodiments of media asset interactive search. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The example methods may be described in the general context of computer-executable instructions, which can include software, applications, routines, programs, objects, components, data structures, procedures, modules, functions, and the like.

The methods may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of media asset interactive search. The order in which the method is described is not intended to be construed as a limitation, and any number of the described method blocks can be combined in any order to implement the method, or an alternate method.

At block 302, successive keypad number inputs are received that each correlate to multiple characters of one or more different languages. For example, the asset search service 124 (FIG. 1) receives successive keypad number inputs 152 from a device 104 when initiated by a user, such as with the remote control device 150 to initiate keypad number inputs at television client device 134. Each keypad number input 152 can correlate to characters in one or more different languages that are included in the languages database 142. A character of a particular language can include a letter, a number, a symbol, an image, any other language representation, and/or any combination thereof. Each keypad number input 152 is received as a single triple-tap input to a keypad number where each input is only one input to a particular keypad number.

At block 304, a database is searched for a sequence of characters that correlate to the accumulating search key after each successive keypad number input is received. For example, the keypad number inputs 152 form an accumulating search key 154 as each successive keypad number input is received. Each of the successive keypad inputs are correlated with a respective character, and the languages database 142 is searched for terms that contain the accumulating search key. For example, the asset search service 124 initiates a search of the languages database 142 for a sequence of characters that correlate to the accumulating search key after each successive keypad number input is received.

At block 306, a list of matching terms is generated where the matching terms include the sequence of characters, and the list of matching terms narrows with each successive keypad number input. For example, as more keypad inputs are received, the number of possible matching results is narrowed down and the asset search service 124 generates a list of matching terms for display. A matching term 156 includes any one of a word, a phrase, a sentence, or a character image that includes the sequence of characters that form the search key 154.

At block 308, the list of the matching terms is ordered based on a scoring system. For example, the asset search service 124 orders the list of the matching terms 156 in an order based on a scoring system where the matching terms are evaluated to determine a degree to which the search key 154 matches an entire word, phrase, sentence, or characters, and the score is used to sort the list. The list of matching terms are ordered based on the scoring system from a high score to a low score according to first, a matching term that is the sequence of the characters; next, a matching term that includes the sequence of the characters at a beginning of the matching term; next, a matching term that includes the sequence of the characters proximate a beginning of the matching term; and next, a matching term that includes the sequence of the characters.

At block 310, a display of the list of the matching terms is initiated. For example, the asset search service 124 initiates a display of a list 220 (FIG. 2) of the matching terms that include the sequence of characters highlighted (e.g., bolded in the example) in each list entry to provide user feedback about which keypad number inputs are matching in the list of terms. The matching terms are also displayed in an order based on a high score (1) at 222 to a low score (6) at 224 to indicate which of the matching terms a user is most likely searching for.

FIG. 4 illustrates example method(s) 400 of media asset interactive search. The order in which the method is described is not intended to be construed as a limitation, and any number of the described method blocks can be combined in any order to implement the method, or an alternate method.

At block 402, successive keypad number inputs are received that each correlate to a number of character strokes to create a character image in one or more different languages. For example, the asset search service 124 (FIG. 1) receives successive keypad number inputs 152 that each correlate to a number of character strokes to create a character image, such as one to ten strokes to create a Chinese character if the character was written by hand. The successive keypad number inputs form a character search key 154 as each keypad number input is received.

At block 404, a database is searched for a sequence of the character images that correlate to the character search key after each successive keypad number input is received. For example, the asset search service 124 determines the character image that correlates to a keypad number input from a character mapping 144, and searches the languages database 142 for a sequence of character images that correlate to the character search key 154 after each additional keypad number input is received.

At block 406, a list of matching terms is generated where the matching terms include the sequence of character images, and the list of matching terms narrows with each successive keypad number input. For example, the asset search service 124 generates a list of the matching terms that include the sequence of the character images and, as more keypad inputs are received, the number of possible matching results is narrowed down.

At block 408, the list of the matching terms is ordered based on a scoring system. For example, the asset search service 124 orders the list of the matching terms 156 in an order based on a scoring system where the matching terms are evaluated to determine a degree to which the character search key 154 matches or is included in matching terms. At block 410, a display of the list of the matching terms is initiated. For example, the asset search service 124 initiates a display of a list 220 (FIG. 2) of the matching terms that include the sequence of characters, such as Chinese characters in this example.

FIG. 5 illustrates various components of an example device 500 that can be implemented as any type of portable and/or computer device as described with reference to FIGS. 1 and 2 to implement embodiments of media asset interactive search. Device 500 includes communication devices 502 that enable wired and/or wireless communication of device data 504 (e.g., received data, data that is being received, data scheduled for broadcast, data packets of the data, etc.). The device data 504 or other device content can include configuration settings of the device, media content stored on the device, and/or information associated with a user of the device. Media content stored on device 500 can include any type of audio, video, and/or image data. Device 500 includes one or more data inputs 506 via which any type of data, media content, and/or inputs can be received, such as user-selectable inputs, messages, music, television media content, recorded video content, and any other type of audio, video, and/or image data received from any content and/or data source.

Device 500 also includes communication interfaces 508 that can be implemented as any one or more of a serial and/or parallel interface, a wireless interface, any type of network interface, a modem, and as any other type of communication interface. The communication interfaces 508 provide a connection and/or communication links between device 500 and a communication network by which other electronic, computing, and communication devices communicate data with device 500.

Device 500 includes one or more processors 510 (e.g., any of microprocessors, controllers, and the like) which process various computer-executable instructions to control the operation of device 500 and to implement embodiments of media asset interactive search. Alternatively or in addition, device 500 can be implemented with any one or combination of hardware, firmware, or fixed logic circuitry that is implemented in connection with processing and control circuits which are generally identified at 512. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 500 also includes computer-readable media 514, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 500 can also include a mass storage media device 516.

Computer-readable media 514 provides data storage mechanisms to store the device data 504, as well as various device applications 518 and any other types of information and/or data related to operational aspects of device 500. For example, an operating system 520 can be maintained as a computer application with the computer-readable media 514 and executed on processors 510. The device applications 518 can include a device manager (e.g., a control application, software application, signal processing and control module, code that is native to a particular device, a hardware abstraction layer for a particular device, etc.). The device applications 518 also include any system components or modules to implement embodiments of media asset interactive search. In this example, the device applications 518 include a device manager 522 and an asset search service 524 that are shown as software modules and/or computer applications. Alternatively or in addition, the asset search service 524 can be implemented as hardware, software, firmware, or any combination thereof.

Device 500 also includes an audio and/or video input-output system 526 that provides audio data to an audio system 528 and/or provides video data to a display system 530. The audio system 528 and/or the display system 530 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link. In an embodiment, the audio system 528 and/or the display system 530 are implemented as external components to device 500. Alternatively, the audio system 528 and/or the display system 530 are implemented as integrated components of example device 500.

Although embodiments of media asset interactive search have been described in language specific to features and/or methods, it is to be understood that the subject of the appended claims is not necessarily limited to the specific features or methods described. Rather, the specific features and methods are disclosed as example implementations of media asset interactive search.

1. A method implemented by a computer device, the method comprising:
receiving successive keypad number inputs that each correlate to multiple characters of one or more different languages, the successive keypad number inputs forming an accumulating search key;
searching a database for a sequence of characters that correlate to the accumulating search key after each successive keypad number input is received; and
generating a list of matching terms that include the sequence of characters, the list of matching terms narrowing with each successive keypad number input.

2. A method as recited in claim 1, further comprising determining a matching term from a character mapping that correlates a character of one of the different languages to a keypad number input.

3. A method as recited in claim 1, wherein a matching term includes at least one of a word, a phrase, a sentence, or a character image.

4. A method as recited in claim 1, wherein the list of matching terms are ordered based on a scoring system according to at least one of:
a first matching term that is the sequence of the characters;
a second matching term that includes the sequence of the characters at a beginning of the second matching term;
a third matching term that includes the sequence of the characters proximate a beginning of the third matching term; or
a fourth matching term that includes the sequence of the characters.

5. A method as recited in claim 1, further comprising initiating a display of the list of the matching terms that include at least one of words, phrases, sentences, or character images of the one or more different languages.

6. A method as recited in claim 1, wherein the successive keypad number inputs are each received as a single triple-tap input to a keypad number where each triple-tap input is only one input to a keypad number.

7. A method implemented by a computer device, the method comprising:
receiving successive keypad number inputs that each correlate to a number of character strokes to create a character image in one or more different languages, the successive keypad number inputs forming a character search key;
searching a database for a sequence of the character images that correlate to the character search key after each successive keypad number input is received; and
generating a list of matching terms that include the sequence of the character images, the list of matching terms narrowing with each successive keypad number input.

8. A method as recited in claim 7, further comprising determining the character image that correlates to a keypad number input from a character mapping for one of the different languages.

9. A method as recited in claim 7, further comprising initiating a display of the list of the matching terms in an order based on a scoring system.

10. A method as recited in claim 7, wherein the list of matching terms are ordered based on a scoring system according to at least one of:
a first matching term that is the sequence of the characters;
a second matching term that includes the sequence of the characters at a beginning of the second matching term;
a third matching term that includes the sequence of the characters proximate a beginning of the third matching term; or
a fourth matching term that includes the sequence of the characters.

11. A computer device, comprising:
at least a memory and a processor configured to implement an asset search service configured to:
receive successive keypad number inputs that each correlate to multiple characters of one or more different languages, the successive keypad number inputs forming an accumulating search key;
search a database for a sequence of characters that correlate to the accumulating search key after each successive keypad number input is received; and
generate a list of matching terms that include the sequence of characters, the list of matching terms narrowing with each successive keypad number input.

12. A computer device as recited in claim 11, wherein the asset search service is further configured to receive each of the successive keypad number inputs as a single triple-tap input to a keypad number where each triple-tap input is only one input to a keypad number.

13. A computer device as recited in claim 11, wherein the asset search service is further configured to order the list of the matching terms based on a scoring system according to at least one of:
a first matching term that is the sequence of the characters;
a second matching term that includes the sequence of the characters at a beginning of the second matching term;
a third matching term that includes the sequence of the characters proximate a beginning of the third matching term; or
a fourth matching term that includes the sequence of the characters.

14. A computer device as recited in claim 11, wherein the asset search service is further configured to determine a matching term from a character mapping that correlates a character of one of the different languages to a keypad number input.

15. A computer device as recited in claim 11, wherein a matching term includes at least one of a word, a phrase, a sentence, or a character image.

16. A computer device as recited in claim 11, wherein the asset search service is further configured to initiate a display of the list of the matching terms that include at least one of words, phrases, sentences, or character images of the one or more different languages.

17. A computer device as recited in claim 11, wherein the asset search service is further configured to receive a keypad number input that correlates to a number of character strokes to create a character image in the one or more different languages.

18. A computer device as recited in claim 17, wherein the asset search service is further configured to determine the character image that correlates to the keypad number input from a character mapping for one of the different languages.

19. A computer device as recited in claim 17, wherein the asset search service is further configured to:
receive additional keypad number inputs that each correlate to a number of character strokes to create character images in the one or more different languages, the additional keypad number inputs forming a character search key;
search a database for a sequence of the character images that correlate to the character search key after each additional keypad number input is received; and
generate the list of the matching terms that include the sequence of the character images.

20. A computer device as recited in claim 17, wherein the asset search service is further configured to receive each of the additional keypad number inputs as a single input to a keypad number.
